(19) United States
(12) Patent Application Publication
(10) Pub. No.: US 2008/0162273 A1
(43) Pub. Date: Jul. 3, 2008

(54) SYSTEM AND METHOD OF TRACKING PROCESS FOR MANAGING DECISIONS

(75) Inventor: Quoc-Bao Nguyen, Stamford, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/618,955

(22) Filed: Jan. 2, 2007

(51) Int. Cl. G06Q 10/00

(52) U.S. Cl. 705/11

(57) ABSTRACT

A computer program product and method for improving quality of decisions call for a tracking runtime component, a decision modeling component, and a decision analytics component wherein the tracking runtime component provides for tracking executed decisions; the decision modeling component provides for modeling the executed decisions; and the decision analytics component provides for analyzing past decisions to improve the quality of the decisions.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to managing a decision making process.

2. Description of the Related Art

Businesses suffer millions of dollars in losses each year as a result of flawed decision-making. Despite massive investments in technology to improve management practices, people continue to make bad decisions. Bad decisions can result from any level of the organization such as executive, middle management, and staff. There are a number of reasons why people frequently make poor decisions.

One common reason for poor decision making is that conclusions reached are often based upon poor data. For example, fragmented data, inaccurate data, and lack of data are potential causes of delay and bad decisions. Decision data and business metrics may reside in different databases. It may take hours to gather and correlate relevant decision data. Employees may not even know that some decision data exists.

Employees who follow their “gut instincts” can lose sight of business objectives. While these employees may think they are making correct decisions, the decisions may ultimately prove to have been poorly made as relevant factors and data were not adequately considered.

A decision maker needs to consider numerous factors such as corporate policies, business strategies, past decisions, risk management and market trends. In short, a root cause of many flawed decisions is that some critical factors or data may not have been considered during the decision-making process.

What are needed are software and hardware to improve the quality of decisions.

### SUMMARY OF THE INVENTION

The shortcomings of the prior art are overcome and additional advantages are provided through the provision of a computer program product stored on machine readable media including machine readable instructions for improving the quality of decisions, the instructions include instructions for providing a tracking runtime component, a decision modeling component, and a decision analytics component wherein the tracking runtime component provides for tracking executed decisions; the decision modeling component provides for modeling executed decisions; and the decision analytics component provides for analyzing past decisions to improve the quality of the decisions.

Also disclosed is a computer system including a computer program product having instructions for improving the quality of decisions, the product includes instructions for providing a decision tracking runtime dashboard, decision tracking runtime subsystems, and a decision tracking repository; providing a decision tracking management tool, a decision recommendation tool, a decision execution tool, service handlers, simulation tools, and evaluation tools; providing a tracking controller, a data mediator manager, data mediators, a mediator handler manager, and mediator handlers; providing decision tracking meta data, decision knowledge base, and a data retrieval pool; providing a decision tracking modeling tool, a decision tracking transformation tool, decision tracking runtime elements, and runtime deployment tools; providing contextual decision variables, a contextual input link, performance feedback metrics, and a performance feedback link; providing a decision analytics dashboard, decision analytics service adapters, measurement ETLs, and decision multidimensional analytics data; and providing a dashboard GUI, a decision history management tool, multidimensional decision analytics, and measurement functions.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution in which a computer program product stored on machine readable media includes machine readable instructions for improving the quality of decisions, the instructions include instructions for providing a tracking runtime component, a decision modeling component, and a decision analytics component wherein the tracking runtime component provides for tracking executed decisions; the decision modeling component provides for modeling executed decisions; and the decision analytics component provides for analyzing past decisions to improve the quality of the decisions.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 depicts aspects of one exemplary embodiment for implementing a decision method;

FIG. 3 depicts aspects of identities associated with a decision tracking modeling tool;

FIG. 4 depicts various aspects of the decision tracking modeling tool;

FIG. 5 depicts aspects of a decision tracking runtime dashboard;

FIG. 6 depicts aspects of decision tracking runtime subsystems;

FIG. 7 depicts aspects of a decision tracking repository;

FIG. 8 depicts aspects of a decision analytics dashboard; and

FIG. 9 presents a method for improving the quality of decisions.

The detailed description explains the preferred embodiments of the invention, together with advantages and features, by way of example with reference to the drawings.

### DETAILED DESCRIPTION OF THE INVENTION

The teachings herein provide techniques for improving the quality of decisions. A primary focus of a system employing the techniques is to bind the decision to up-to-date data and objectives. The techniques include a process having three parts. In a first part, a modeling process determines a context in which decisions are made and also measures an effectiveness of decisions. In a second part, a tracking process provides for tracking decisions as well as the context. In a third part, an analysis process analyzes past decisions. Each of the three parts is linked together, and operates to provide iterative refinement of decision making.

As a general example, a user will call upon the system to make a decision regarding procurement of a material from one supplier or another supplier. Inputs to the system include information regarding aspects such as cost, delivery charges, delivery schedule, quality, and warranty. Other inputs will include objectives such as profitability and customer satisfaction. The decision provided will simply be a selection of the best supplier with respect to the up-to-date data and objectives. However, the system will take advantage of other information such as internal clients, test data such as product failure modes for each type of material, and experiential data including customer satisfaction with products having each of the materials. Of course, procurement is but one example, and is therefore merely illustrative.

Accordingly, the system includes a variety of tools for making decisions. Linking the three parts together provides for improving the quality of decisions. Linking insures that the decision-maker has access to analyses of past decisions, up-to-date data and objectives, and appropriate decision-making tools and services. As one skilled in the art might surmise, each part of the technique includes a number of components. However, prior to discussing aspects of the various parts, certain definitions are provided.

As used herein, the term “relevant data” relates to data that the decision maker needs to aid in making the decision. The term “critical factors” relates to concepts such as strategies, goals, risk tolerance, and market trends. The term “ETL” relates to an extract, transform, load function performed on data. For example, data is extracted from a database, transformed, and then loaded in an application. The terms “runtime elements,” “runtime components,” and “configuration components” relate to elements of software for implementing the teachings herein. The term “metrics” relates to data that are typically used to measure effectiveness of decisions. The term “root cause” relates to the earliest event in a decision chain whose interruption would have changed the decision outcome. The term “stereotype links” relates to a predefined link between at least two sets of data. The term “critical decision variables” relates to those variables that contribute to making the decision. The term “multidimensional” relates to analyzing at least one type of information (such as the decision) with respect to at least one other type of information (for example, supplier warranty).

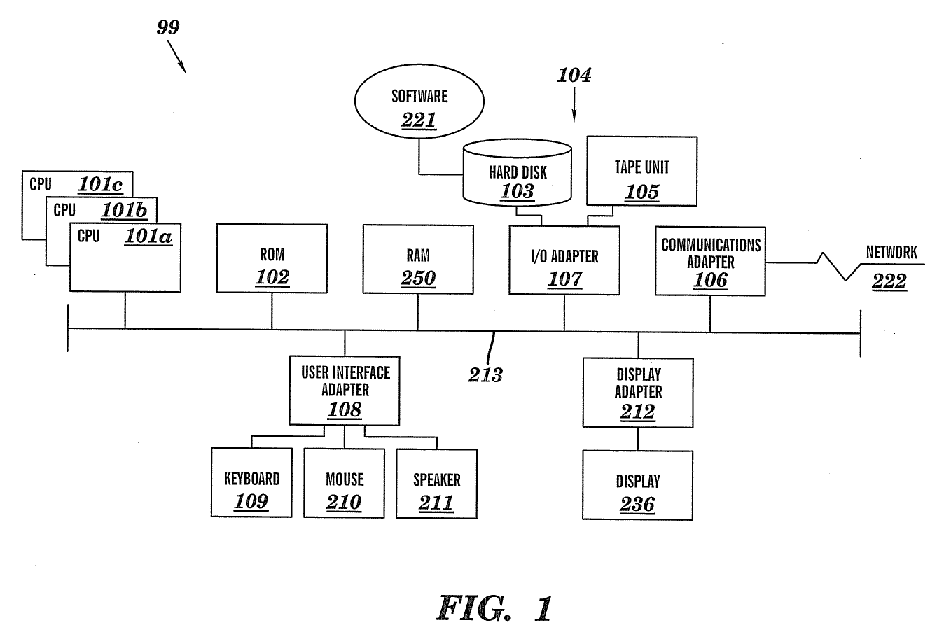

Referring now to FIG. 1, an embodiment of a computer processing system 99 for implementing the teachings herein is depicted. System 99 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 213. Read only memory (ROM) 102 is coupled to the system bus 213 and may include a basic input/output system (BIOS), which controls certain basic functions of system 99.

FIG. 1 further depicts an I/O adapter 107 and a network adapter 106 coupled to the system bus 213. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. The network adapter 106 interconnects bus 113 with a network 222 enabling data processing system 99 to communicate with other such systems. The network 222 can be a local-area network (LAN), a metro-area network (MAN), or wide-area network (WAN), such as the Internet or World Wide Web. Display monitor 236 is connected to system bus 213 by display adaptor 212, which may include a graphics adapter to improve the performance of graphics intensive applications and a video controller. In one embodiment, adapters 107, 106, and 212 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 213 via user interface adapter 108 and display adapter 212. A keyboard 109, mouse 210, and speaker 211 all interconnected to bus 213 via user interface adapter 108, which may include, for example, a Super I/O chip integrating multiple device adapters into a single integrated circuit.

As disclosed herein, the system 99 includes machine readable instructions stored on machine readable media (for example, the hard disk 103) for providing improved quality of decisions. As disclosed herein, the instructions are referred to as decision method software 221. Typically, the software 221 includes instructions for generating runtime elements. The software 221 may be produced using software development tools as are known in the art. The software 221 may be provided as an “add-in” to an application (where “add-in” is taken to mean supplemental program code as is known in the art). In such embodiments, the software 221 replaces or supplements structures of the application for providing decisions.

Thus, as configured FIG. 1, the system 99 includes processing means in the form of processors 101, storage means including system memory 250 and mass storage 104, input means such as keyboard 109 and mouse 210, and output means including speaker 211 and display 236. In one embodiment a portion of system memory 250 and mass storage 104 collectively store an operating system such as the AIX® operating system from IBM Corporation to coordinate the functions of the various components shown in FIG. 1.

It will be appreciated that the system 99 can be any suitable computer, Windows-based terminal, wireless device, information appliance, RISC Power PC, X-device, workstation, mini-computer, mainframe computer, cell phone, personal digital assistant (PDA) or other computing device.

Examples of other operating systems supported by the system 99 include versions of Windows, Macintosh, Java, LINUX, and UNIX, or other suitable operating systems.

Users of the system 99 can connect to the network 222 through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

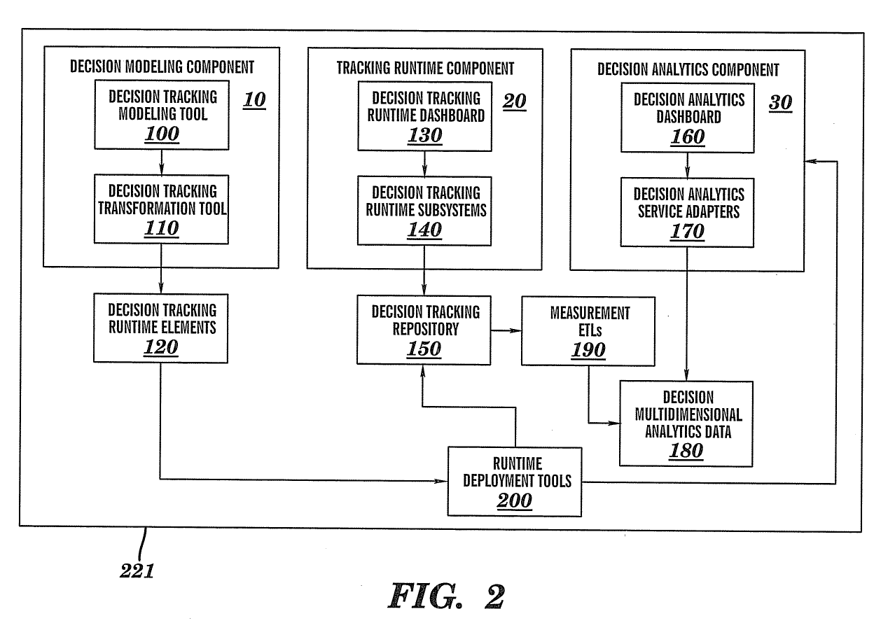

FIG. 2 depicts aspects of one exemplary embodiment of the software 221 for implementing the decision method. As shown in FIG. 2, the modeling process is provided by a decision modeling component 10. The tracking process is provided by a tracking runtime component 20. The analysis process is provided by a decision analytics component 30. Linking the decision modeling component 10, the tracking runtime component 20, and the decision analytics component 30 are decision tracking runtime elements 120, a decision tracking repository 150, measurement ETLs 190, decision multidimensional analytics data 180, and runtime deployment tools 200.

The decision modeling component 10 captures the context in which decisions are made. The decision modeling component 10 includes critical decision variables that lead to the decision, results of the decision, and utility functions that measure effectiveness of the decision. The decision modeling component 10 makes this information available for use with the tracking runtime component 20 and the decision analytics component 30. The decision modeling component 10 includes a decision tracking modeling tool 100 and a decision tracking transformation tool 110. To capture the context and effectiveness, the decision tracking modeling tool 100 constructs relationships between entities such as a strategy, a goal, a decision and an action. Based on a decision model constructed by the decision tracking modeling tool 100, the decision tracking transformation tool 110 transforms the decision model to the decision tracking runtime elements 120.

The decision tracking modeling tool 100 includes a set of stereotype links for defining a tracking relationship. Typically, for each decision action, the context to be captured includes critical decision variables. The critical decision variables typically include relevant data and critical factors. The stereotype links automatically couple the decision to the critical decision variables. Other stereotype links may couple the decision to the entities. In the decision tracking modeling tool 100, the stereotype links are used to make connections from at least one critical decision variable that leads to the decision, to execution of the decision via at least one action, and finally to the impact of the decision on other variables. In addition, the utility functions can be attached to each decision for measuring the effectiveness of the decision-making process.

The decision tracking modeling tool 100 selects which metrics are used to measure the effectiveness of the decision. By measuring the effectiveness of decisions, the decision tracking modeling tool 100 provides a way to identify a root cause of poorly made decisions.

In one illustrative example for the teachings herein, if the decision is made to purchase ten percent more raw materials because product sales are increasing at a ten percent rate, then the stereotype link is created to capture the purchase decision coupled to the product sales increase rate. Many more stereotype links may be created such as between the decision and market trends for the product. Another stereotype link may be created coupling the decision to product sales to measure the decision effectiveness. Percent increase in profits may be another metric used to create a stereotype link with the decision.

The decision tracking transformation tool 110 provides the decision model to the decision tracking runtime elements 120. The decision tracking runtime elements 120 extract information such as the critical decision variables and metrics from the decision model. For the example above, the decision tracking runtime elements 120 would extract the purchase decision, the critical decision variables such as the product sales increase rate and market trends, and the metrics such as the product sales and the percentage increase in profits.

The tracking runtime component 20 includes a decision tracking runtime dashboard 130 and decision tracking runtime subsystems 140. The decision tracking runtime dashboard 130 provides the decision-maker the opportunity to make decisions by at least one of a manual process and an automatic process. The decision tracking runtime dashboard 130 provides the decision-maker with many decision-making aids. For example, with the decision tracking runtime dashboard 130, the decision-maker can browse a history of past decisions. Typically, the decision-maker will be provided with the critical decision variables and metrics by the decision tracking runtime dashboard 130. The metrics provide the decision-maker the types of data that will be used to measure the effectiveness of the decision. Also, typically, the decision-maker can simulate decisions and evaluate alternative decisions. As another example, the decision-maker may request recommendations for specific situations. The decision tracking runtime dashboard 130 guides the decision-maker to bind decisions with the critical decision variables and metrics.

For the illustrative example above, the decision tracking runtime dashboard 130 provides the decision-maker with the percent increase in product sales, product sales, market trends, and percent increase in profits. In one scenario, the decision-maker can simulate the purchase of ten percent more raw materials to determine the percent increase in profits. In another scenario, the decision-maker can evaluate the product sales resulting from both the purchase of ten percent more raw materials and a purchase of thirty percent more raw materials. In yet another scenario, the decision-maker can request a recommendation for the purchase of raw materials from the decision tracking runtime dashboard 130.

The decision tracking runtime subsystems 140 extracts the decisions and associated information such as the critical decision variables from the decision tracking runtime dashboard 130. From the decisions and associated information, the decision tracking runtime subsystems 140 creates runtime components.

The decision analytics component 30 includes a decision analytics dashboard 160 and decision analytics service adaptors 170. The decision analytics dashboard 160 enables one to view and analyze decision data in different dimensions. The decision analytics dashboard 160 uses the decision tracking runtime elements 120. The decision analytics dashboard 160 enables one to build decision multidimensional analytics data 180. Typically, the decision multidimensional analytics data 180 is where analysis functions are applied. For the illustrative example above, one can analyze the decision to purchase ten percent more raw materials by reviewing the resulting product sales and any increase in profits. At a higher level, one can determine how the purchase decision relates to the strategy and goals. The results of these analyses can be stored in the decision multidimensional analytics data 180. For another analysis, one can retrieve information from the decision multidimensional analytics data 180 to review all past decisions to purchase raw materials and the resulting effects.

The decision analytics service adapters 170 provide an interface between the analytics dashboard 160 and the decision multidimensional analytics data 180.

The decision tracking runtime elements 120 are input to runtime deployment tools 200. For the illustrative example above, the runtime elements 120 include the decision to purchase ten percent more raw materials and the critical decision variables such as the percent increase in the product sales rate and market trends. The decision tracking runtime elements 120 may also include metrics such as the products sales and the percent increase in profits. The runtime deployment tools 200 configure both the tracking runtime component 20 and the decision analytics component 30 using the decision tracking runtime elements 120. The runtime deployment tools 200 also store the runtime elements 120 with the decision tracking repository 150. Additionally, the decision tracking repository 150 stores the runtime components from the tracking runtime component 20. The measurement ETLs 190 extract data from the tracking repository 150, transform the data, and load the transformed data to the multidimensional analytics data 180.

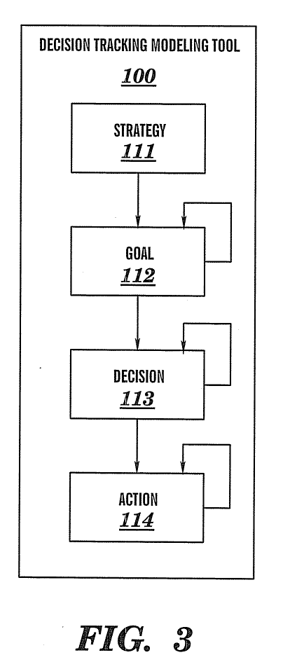

FIG. 3 depicts aspects of relationships between the entities. Typically, the relationships are based on a hierarchy. A strategy 111 includes at least one goal 112. The goal 112 can be accomplished by at least one decision 113. Execution of the decision 113 may take at least one action 114. The action 114 may be at least one of a theoretical action (such as performing a study) or an executable action (such as purchasing raw materials). For the example above, the strategy 111 may be to increase total profits. The goal 112 may be to increase product sales by ten percent. The decision 113 is to increase the purchase of raw materials by ten percent. The resulting actions 114 may be to increase product production by ten percent.

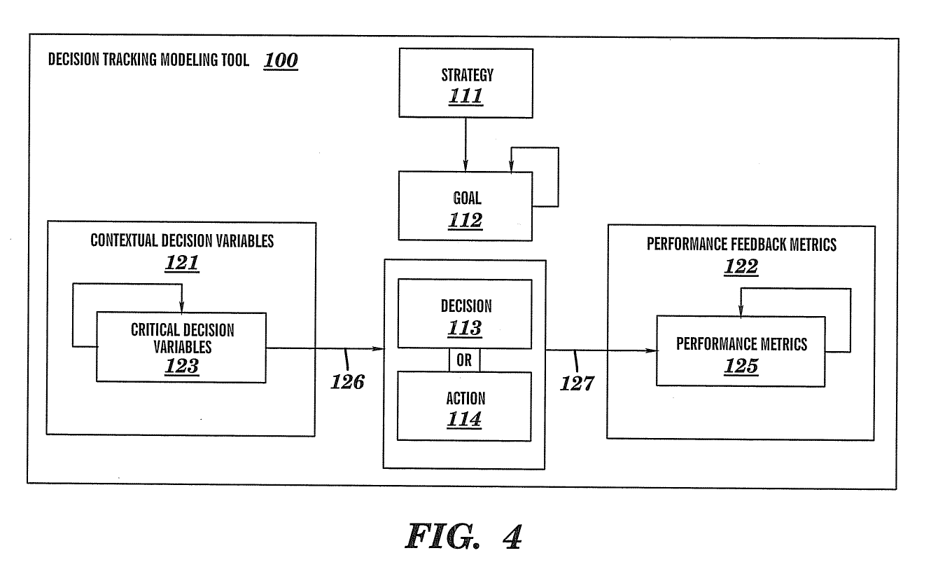

FIG. 4 depicts aspects of capturing the context and the effectiveness of the decisions 113 in the decision tracking modeling tool 100. Typically, the context is captured by linking the critical decision variables to at least one of the decision 113 and the actions 114. Decision effectiveness is captured by linking at least one of the decision 113 and the actions 114 with performance data (metrics). Contextual decision variables 121 include critical decision variables 123. The decision tracking modeling tool 100 includes a contextual input link 126 between the critical decision variables 123 and at least one of the decision 113 and the actions 114. A performance feedback metrics 122 measures the effectiveness of at least one of the decision 113 and the actions 114. The performance feedback metrics 122 include a performance metrics 125. The decision tracking modeling tool 100 also includes a performance feedback link 127 between at least one of the decision 113 and the actions 114 and the performance metrics 125.

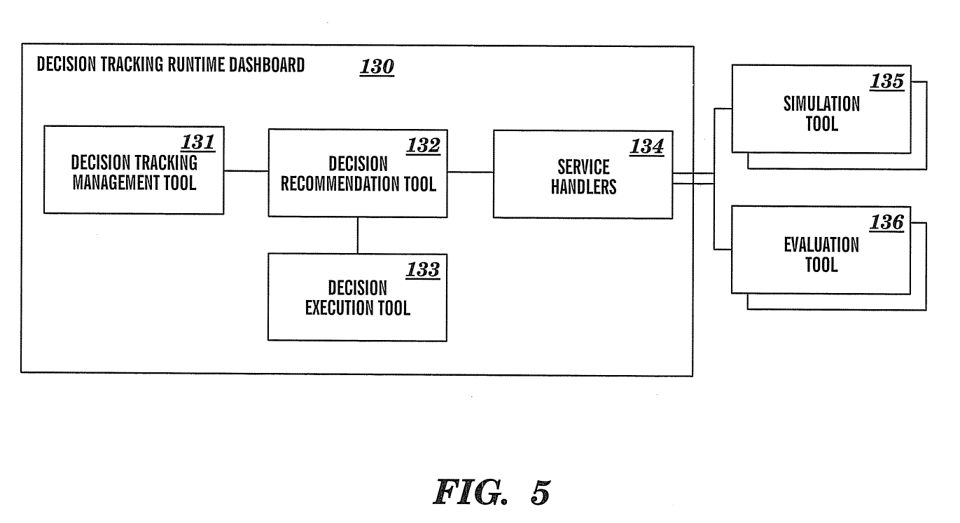

FIG. 5 depicts various aspects of the decision tracking runtime dashboard 130. A decision recommendation 132 provides the decision-maker with up-to-date information such as the critical decision variables 123 and the performance metrics 125. A plurality of simulation tools 135 allows the decision-maker to simulate results of the decision 113. A plurality of evaluation tools 136 allows the decision-maker to evaluate the results of the alternative decisions 113. Typically, the simulation tools 135 and the evaluation tools 136 are provided to the decision recommendation tool 132 via service handlers 134. The decisions 113 are made via a decision execution tool 133. With the decision execution tool 133, decisions are made at least one of manually and automatically. The decisions 113 and the information such as the critical variables 123 are tracked with a decision tracking management tool 131.

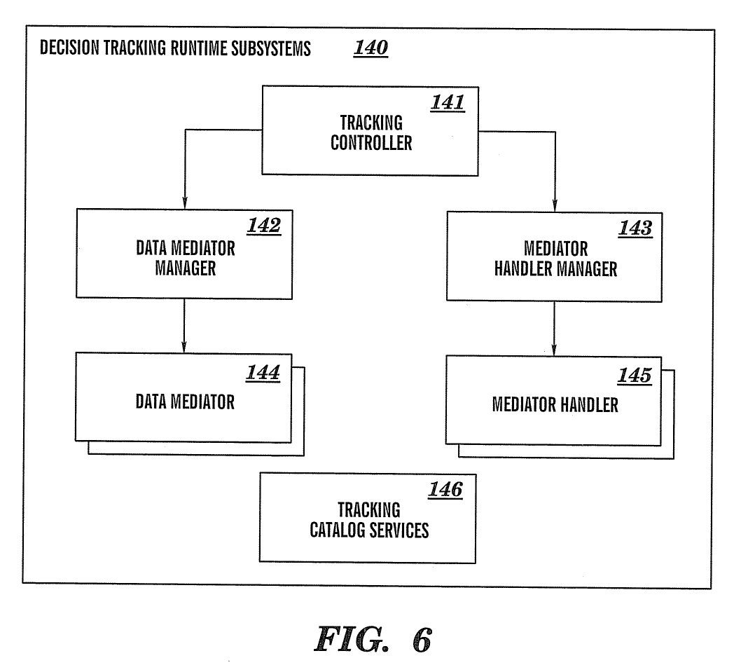

FIG. 6 depicts aspects of the decision tracking runtime subsystems 140. The decision tracking runtime subsystems 140 create runtime components with information such as the decisions 113 and critical decision variables 123. The runtime components are stored with the decision tracking repository 150. Typically, a tracking controller 141 controls the process using data mediators and mediator handlers. Data mediators and data handlers allow data to be stored and retrieved in databases. The data mediators typically track decisions and collect data. The data handlers typically, among other things, trigger actions to send and receive data. The decision tracking runtime subsystems 140 include a data mediator manager 142 to control a plurality of data mediators 144. The decision tracking runtime subsystems 140 include a mediator handler manager 143 to control a plurality of mediator handlers 145. The decision tracking runtime subsystems 140 may also include tracking catalog services 146. Typically, the tracking catalog services 146 maintain an inventory of data in the tracking repository 150.

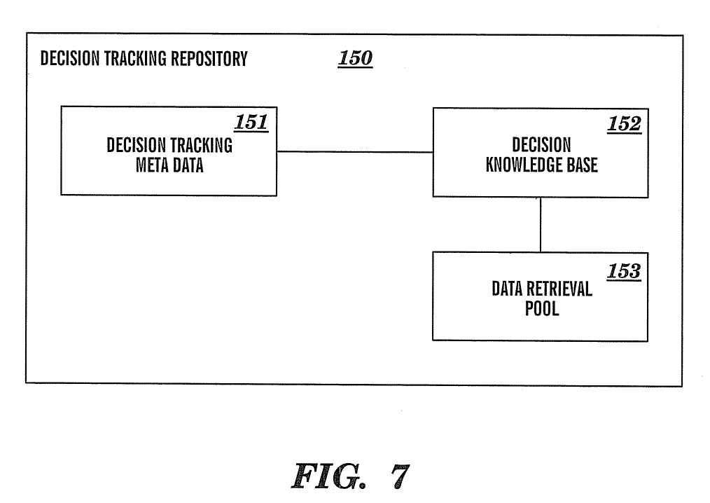

FIG. 7 depicts various aspects of the decision tracking repository 150. The decision tracking repository 150 stores the runtime components and the decision tracking runtime elements 120 via the runtime deployment tools 200. Typically, the decision tracking repository 150 includes tracking meta data 151, a decision knowledge base 152, and a data retrieval pool 153. The meta data 151 provides information about the data in the repository 150. The knowledge base 152 stores the data. The data retrieval pool 153 retrieves the data stored in the knowledge base 152.

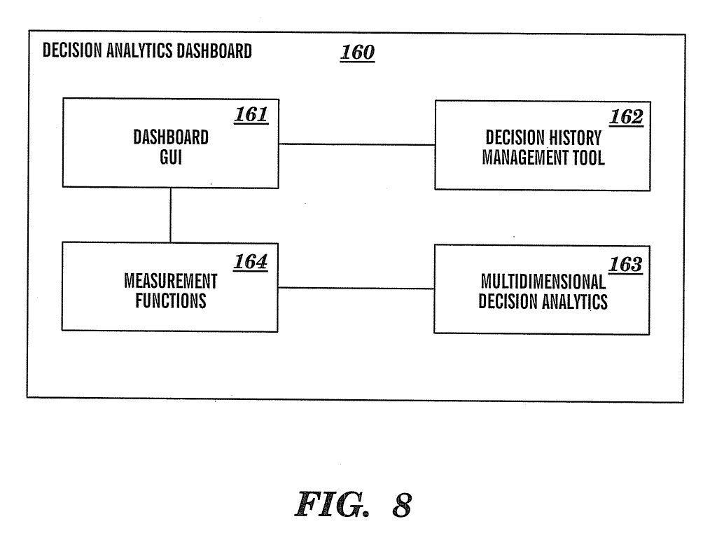

FIG. 8 depicts various aspects of the decision analytics dashboard 160. Typically, a dashboard graphical user interface (GUI) 161 provides an interface with the user. A decision history management tool 162 provides the user access to decision history data in the multidimensional analytics data 180. Measurement functions 164 include a plurality of measurement functions that the user may apply to the multidimensional analytics data 180. Multidimensional decision analytics 163 are used to perform multidimensional decision analyses using the measurement functions 164. Using the illustrative example above, the decision history management tool 162 can provide the user with all past decisions 113 for purchasing raw materials, the associated critical decision variables 123 such as product sales increase rate and market trends, and the resulting performance metrics 125 such as product sales and percent increase in profits. Multidimensional data analysis may be performed to measure profitability at corporate level, at division level, and at department level. The results of these analyses may be stored with the multidimensional analytics data 180.

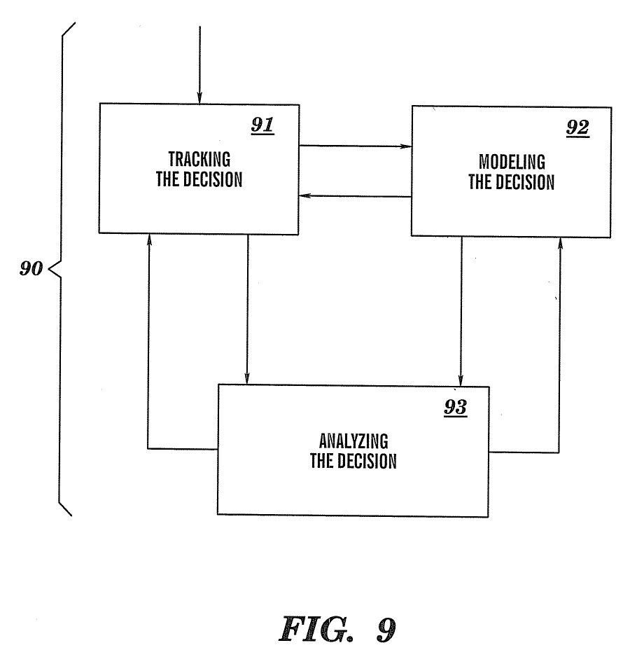

FIG. 9 is a flow diagram of a method 90 for improving the quality of the decision 113. Referring to FIG. 9, a first step 91 calls for making the decision 113 with the tracking runtime component 20. The first step 91 may include reviewing the critical decision variables 123 and the performance metrics 125. The first step 91 may also include performing simulations of the decision 113 and evaluations of the alternative decisions 113. Typically, one may make the decision 113 by at least one of the manual and automatic processes. Once the decision 113 is executed, the decision 113 becomes the executed decision 113. Typically, the first step 91 includes tracking the executed decision 113 and the associated critical decision variables 123.

Typically, the first step 91 includes sending and receiving data (the executed decision 113 and the critical decision variables 123 for example) with both the decision modeling component 10 and the decision analytics component 30. The first step 91 also includes receiving data such as relevant data and critical factors from outside sources.

A second step 92 calls for modeling the executed decision 113. Typically, the executed decision 113 context and effectiveness are captured with the decision modeling component 10. The software 221 typically provides for reviewing the set of stereotype links and coupling the executed decision 113 to the critical decision variables 123 and to the performance metrics 125. The second step 92 may include creating decision tracking runtime elements 120.

Typically, the second step 92 includes sending and receiving data (the decision tracking runtime elements 120 as one example) with both the tracking runtime component 20 and the decision analytics component 30.

A third step 93 calls for analyzing past decisions 113. Typically, analyzing the past decisions 113 is performed with the decision analytics component 30. The third step 93 may include building the decision multidimensional data 180. The third step 93 may also include performing analyses on the decision multidimensional analytics data 180.

Typically, the third step 93 includes sending and receiving data with both the tracking runtime component 20 and the decision modeling component 10.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media comprising machine readable instructions for improving the quality of decisions, the instructions comprising instructions for:
providing a tracking runtime component, a decision modeling component, and a decision analytics component;
wherein the tracking runtime component provides for tracking executed decisions;
the decision modeling component provides for modeling the executed decisions; and
the decision analytics component provides for analyzing past decisions to improve the quality of the decisions.

2. The computer program product as in claim 1, wherein the tracking runtime component comprises at least one of a decision tracking runtime dashboard, decision tracking runtime subsystems, and a decision tracking repository.

3. The computer program product as in claim 1, further comprising at least one of a decision tracking management tool, a decision recommendation tool, a decision execution tool, service handlers, simulation tools, and evaluation tools.

4. The computer program product as in claim 1, further comprising at least one of a tracking controller, a data mediator manager, data mediators, a mediator handler manager, and mediator handlers.

5. The computer program product as in claim 1, further comprising at least one of decision tracking meta data, a decision knowledge base, and a data retrieval pool.

6. The computer program product as in claim 1, wherein the decision modeling component comprises at least one of a decision tracking modeling tool, a decision tracking transformation tool, decision tracking runtime elements, and runtime deployment tools.

7. The computer program product as in claim 1, further comprising at least one of contextual decision variables, a contextual input link, performance feedback metrics, and a performance feedback link.

8. The computer program product as in claim 1, wherein the decision analytics component comprises at least one of a decision analytics dashboard, decision analytics service adapters, measurement ETLs, and decision multidimensional analytics data.

9. The computer program product as in claim 1, further comprising at least one of a dashboard GUI, a decision history management tool, multidimensional decision analytics, and measurement functions.

10. The computer program product as in claim 1, wherein the product is an add-in.

11. A computer system comprising a computer program product having instructions for improving the quality of decisions, the product comprising instructions for:
providing a decision tracking runtime dashboard, decision tracking runtime subsystems, and a decision tracking repository;
providing a decision tracking management tool, a decision recommendation tool, a decision execution tool, service handlers, simulation tools, and evaluation tools;
providing a tracking controller, a data mediator manager, data mediators, a mediator handler manager, and mediator handlers;
providing decision tracking meta data, decision knowledge base, and a data retrieval pool;
providing a decision tracking modeling tool, a decision tracking transformation tool, decision tracking runtime elements, and runtime deployment tools;
providing contextual decision variables, a contextual input link, performance feedback metrics, and a performance feedback link;
providing a decision analytics dashboard, decision analytics service adapters, measurement ETLs, and decision multidimensional analytics data; and
providing a dashboard GUI, a decision history management tool, multidimensional decision analytics, and measurement functions.
